(19) United States
(12) Patent Application Publication
(10) Pub. No.: US 2023/0061752 A1
(43) Pub. Date: Mar. 2, 2023

(54) SYSTEM AND METHOD FOR MACHINE LEARNING ARCHITECTURE WITH SELECTIVE LEARNING

(71) Applicant: ROYAL BANK OF CANADA, Toronto (CA)

(72) Inventors: Xiao Qi Shi, Toronto (CA); Hasham Burhani, Peterborough (CA)

(21) Appl. No.: 17/893,302

(22) Filed: Aug. 23, 2022

Related U.S. Application Data
(60) Provisional application No. 63/236,429, filed on Aug. 24, 2021.

(51) Int. Cl. G06Q 40/04; G06Q 30/02

(52) U.S. Cl. CPC G06Q 40/04; G06Q 30/0201; G06N 3/08

(57) ABSTRACT

Systems, devices, and methods for training an automated agent are disclosed. An automated agent is instantiated. The automated agent includes a reinforcement learning neural network that is trained over a plurality training cycles and provides a policy for generating resource task requests. A learning condition that is expected to impede training of the automated agent during a given training cycle of the plurality of training cycles is detected. In response to the detecting, a disable signal is generated to disable training of the automated agent for at least the given training cycle.

### CROSS-REFERENCE TO RELATED APPLICATION

This application claims the benefit of and priority to U.S. patent application No. 63/236,429 filed on Aug. 24, 2021, the entire content of which is herein incorporated by reference.

### FIELD

The present disclosure generally relates to the field of computer processing and reinforcement learning.

### BACKGROUND

A reward system is an aspect of a reinforcement learning neural network, indicating what constitutes good and bad results within an environment. Learning by reinforcement learning can require a large amount of data. Learning by reinforcement learning processes can be slow.

### SUMMARY

In an aspect, there is provided a computer-implemented system for training an automated agent. The system includes a communication interface; at least one processor; memory in communication with the at least one processor; and software code stored in the memory. The software code, when executed at the at least one processor causes the system to: instantiate an automated agent that includes a reinforcement learning neural network that is trained over a plurality training cycles and provides a policy for generating resource task requests within an environment under exploration by the automated agent; detect a learning condition that is expected to impede training of the automated agent during a given training cycle of the plurality of training cycles; and in response to the detecting, generate a disable signal to disable training of the automated agent for at least the given training cycle.

In the system, the software code, when executed at the at least one processor may further cause the system to: receive state data reflective of a current state of the environment.

In the system, the detecting the learning condition may include processing the state data to determine that the learning condition restricts the automated agent given the current state of the environment.

In the system, the learning condition may include a user-imposed restriction that restricts the automated agent from generating a resource task request in accordance with its policy.

In the system, the learning condition may include a limit price, and the current state may include a market price.

In the system, the learning condition may include an atypical condition of the environment.

In the system, the environment may includes at least one trading venue.

In the system, the software code, when executed at the at least one processor may further cause the system to: upon receiving the disable signal, disable processing of a reward for the given training cycle.

In the system, the software code, when executed at the at least one processor may further cause the system to: upon receiving the disable signal, disable providing the state data to the reinforcement learning neural network for the given training cycle.

In another aspect, there is provided a computer-implemented method for training an automated agent. The method includes: instantiating an automated agent that includes a reinforcement learning neural network that is trained over a plurality training cycles and provides a policy for generating resource task requests within an environment under exploration by the automated agent; detecting a learning condition that is expected to impede training of the automated agent during a given training cycle of the plurality of training cycles; and in response to the detecting, generating a disable signal to disable training of the automated agent for at least the given training cycle.

The method may further include generating a reward for the reinforcement learning neural network.

The method may further include, when the learning condition is not detected, providing the reward to the reinforcement learning neural network.

The method may further include receiving state data reflective of a current state of the environment.

The method may further include, when the learning condition is not detected, providing the state data to the reinforcement learning neural network.

In the method, the detecting the learning condition may include processing the state data to determine that the learning condition is expected to impede training of the automated agent given the current state of the environment.

In the method, the learning condition may include a user-imposed restriction that restricts the automated agent from generating a resource task request in accordance with its policy.

In the method, the user-imposed restriction may include a limit price, and the current state may include a market price.

In the method, the learning condition may include an atypical condition of the environment.

The method may further include upon receiving the disable signal, disabling processing of a reward for the given training cycle.

The method may further include upon receiving the disable signal, disable providing the state data to the reinforcement learning neural network for the given training cycle.

In another aspect, there is provided a non-transitory computer-readable storage medium storing instructions which when executed adapt at least one computing device to: instantiate an automated agent that includes a reinforcement learning neural network that is trained over a plurality training cycles and provides a policy for generating resource task requests; detect a learning condition that is expected to impede training of the automated agent during a given training cycle of the plurality of training cycles; and in response to the detecting, generating a disable signal to disable training of the automated agent for at least the given training cycle.

Before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### BRIEF DESCRIPTION OF THE FIGURES

In the Figures, which illustrate example embodiments,

FIG. 1A is a schematic diagram of a computer-implemented system for providing an automated agent, in accordance with an embodiment;

FIG. 1B is a schematic diagram of an automated agent, in accordance with an embodiment;

FIG. 1C is a schematic diagram of an example neural network maintained at the computer-implemented system of FIG. 1A, in accordance with an embodiment;

FIG. 2A is an example screen from a lunar lander game, in accordance with an embodiment;

FIGS. 2B and 2C each shows a screen shot of a chatbot implemented using an automated agent, in accordance with an embodiment;

FIG. 3 is a schematic diagram of a selective training controller, in accordance with an embodiment;

FIG. 4 depicts example processing of a buy order, in accordance with an embodiment;

FIG. 5 depicts example processing of a buy order with operation of the selective training controller of FIG. 3, in accordance with an embodiment;

FIG. 6 is a flowchart showing example operation of the system of FIG. 1A and the selective training controller of FIG. 3, in accordance with an embodiment; and

FIG. 7 is a schematic diagram of a system having a plurality of automated agents, in accordance with an embodiment.

### DETAILED DESCRIPTION

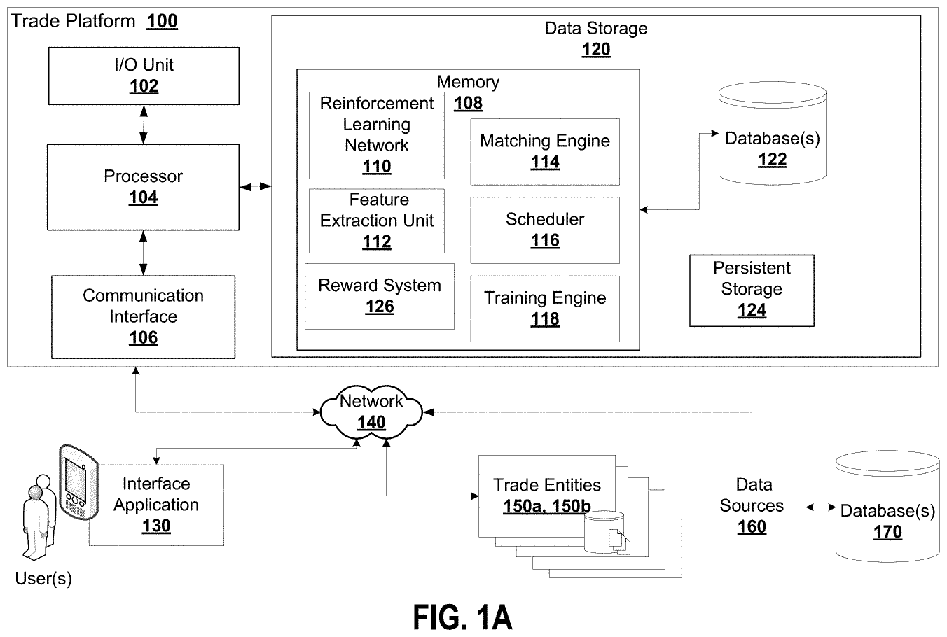

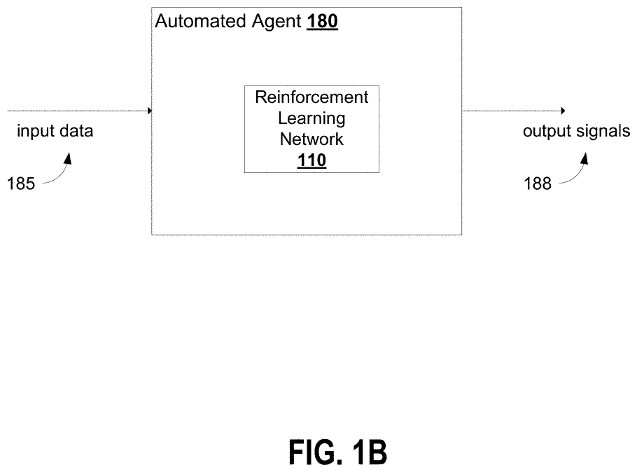

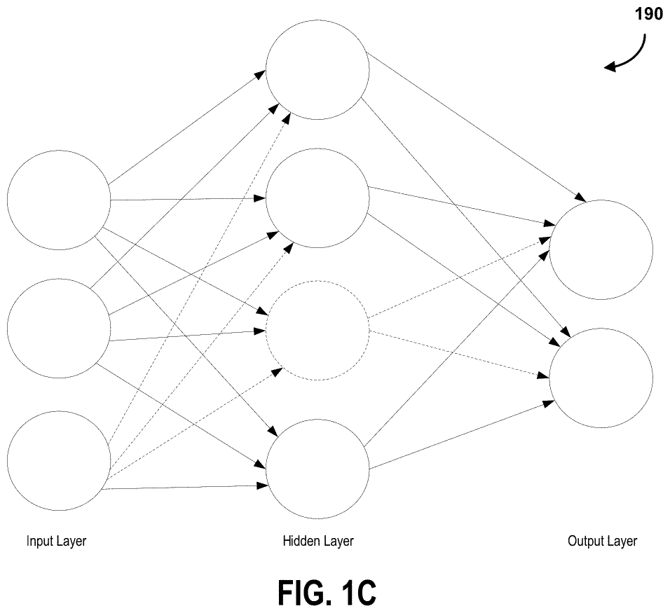

FIG. 1A is a high-level schematic diagram of a computer-implemented system 100 for providing an automated agent having a neural network, in accordance with an embodiment. The automated agent is instantiated and trained by system 100 in manners disclosed herein to generate task requests.

As detailed herein, in some embodiments, system 100 includes features adapting it to perform certain specialized purposes, e.g., to function as a trading platform. In such embodiments, system 100 may be referred to as trading platform 100 or simply as platform 100 for convenience. In such embodiments, the automated agent may generate requests for tasks to be performed in relation to securities (e.g., stocks, bonds, options or other negotiable financial instruments). For example, the automated agent may generate requests to trade (e.g., buy and/or sell) securities by way of a trading venue.

Referring now to the embodiment depicted in FIG. 1A, trading platform 100 has data storage 120 storing a model for a reinforcement learning neural network. The model is used by trading platform 100 to instantiate one or more automated agents 180 (FIG. 1B) that each maintain a reinforcement learning neural network 110 (which may be referred to as a reinforcement learning network 110 or network 110 for convenience).

A processor 104 is configured to execute machine-executable instructions to train a reinforcement learning network 110 based on a reward system 126. The reward system generates good (or positive) signals and bad (or negative) signals to train automated agents 180 to perform desired tasks more optimally, e.g., to minimize and maximize certain performance metrics. In some embodiments, an automated agent 180 may be trained by way of signals generated in accordance with reward system 126 to minimize Volume Weighted Average Price (VWAP) slippage. For example, reward system 126 may implement rewards and punishments substantially as described in U.S. patent application Ser. No. 16/426,196, entitled “Trade platform with reinforcement learning”, filed May 30, 2019, the entire contents of which are hereby incorporated by reference herein.

In some embodiments, trading platform 100 can generate reward data by normalizing the differences of the plurality of data values (e.g. VWAP slippage), using a mean and a standard deviation of the distribution.

Throughout this disclosure, it is to be understood that the terms “average” and “mean” refer to an arithmetic mean, which can be obtained by dividing a sum of a collection of numbers by the total count of numbers in the collection.

In some embodiments, trading platform 100 can normalize input data for training the reinforcement learning network 110. The input normalization process can involve a feature extraction unit 112 processing input data to generate different features such as pricing features, volume features, time features, Volume Weighted Average Price features, market spread features. The pricing features can be price comparison features, passive price features, gap features, and aggressive price features. The market spread features can be spread averages computed over different time frames. The Volume Weighted Average Price features can be current Volume Weighted Average Price features and quoted Volume Weighted Average Price features. The volume features can be a total volume of an order, a ratio of volume remaining for order execution, and schedule satisfaction. The time features can be current time of market, a ratio of time remaining for order execution, and a ratio of order duration and trading period length.

The input normalization process can involve computing upper bounds, lower bounds, and a bounds satisfaction ratio; and training the reinforcement learning network using the upper bounds, the lower bounds, and the bounds satisfaction ratio. The input normalization process can involve computing a normalized order count, a normalized market quote and/or a normalized market trade. The platform 100 can have a scheduler 116 configured to follow a historical Volume Weighted Average Price curve to control the reinforcement learning network 110 within schedule satisfaction bounds computed using order volume and order duration.

The platform 100 can connect to an interface application 130 installed on user device to receive input data. Trade entities 150a, 150b can interact with the platform to receive output data and provide input data. The trade entities 150a, 150b can have at least one computing device. The platform 100 can train one or more reinforcement learning neural networks 110. The trained reinforcement learning networks 110 can be used by platform 100 or can be for transmission to trade entities 150a, 150b, in some embodiments. The platform 100 can process trade orders using the reinforcement learning network 110 in response to commands from trade entities 150a, 150b, in some embodiments.

The platform 100 can connect to different data sources 160 and databases 170 to receive input data and receive output data for storage. The input data can represent trade orders. Network 140 (or multiple networks) is capable of carrying data and can involve wired connections, wireless connections, or a combination thereof. Network 140 may involve different network communication technologies, standards and protocols, for example.

The platform 100 can include an I/O unit 102, a processor 104, communication interface 106, and data storage 120. The I/O unit 102 can enable the platform 100 to interconnect with one or more input devices, such as a keyboard, mouse, camera, touch screen and a microphone, and/or with one or more output devices such as a display screen and a speaker.

The processor 104 can execute instructions in memory 108 to implement aspects of processes described herein. The processor 104 can execute instructions in memory 108 to configure a data collection unit, interface unit (to provide control commands to interface application 130), reinforcement learning network 110, feature extraction unit 112, matching engine 114, scheduler 116, training engine 118, reward system 126, and other functions described herein. The processor 104 can be, for example, any type of general-purpose microprocessor or microcontroller, a digital signal processing (DSP) processor, an integrated circuit, a field programmable gate array (FPGA), a reconfigurable processor, or any combination thereof.

As depicted in FIG. 1B, automated agent 180 receives input data (via a data collection unit) and generates output signal according to its reinforcement learning network 110 for provision to trade entities 150a, 150b. Reinforcement learning network 110 can refer to a neural network that implements reinforcement learning.

FIG. 1C is a schematic diagram of an example neural network 190, in accordance with an embodiment. The example neural network 190 can include an input layer, one or more hidden layers, and an output layer. The neural network 190 processes input data using its layers based on reinforcement learning, for example. The neural network 190 is an example neural network for the reinforcement learning network 110 of the automated agent 180.

Reinforcement learning is a category of machine learning that configures agents, such the automated agents 180 described herein, to take actions in an environment to maximize a notion of a reward. The processor 104 is configured with machine executable instructions to instantiate an automated agent 180 that maintains a reinforcement learning neural network 110 (also referred to as a reinforcement learning network 110 for convenience), and to train the reinforcement learning network 110 of the automated agent 180 using a training unit 118. The processor 104 is configured to use the reward system 126 in relation to the reinforcement learning network 110 actions to generate good signals and bad signals for feedback to the reinforcement learning network 110. In some embodiments, the reward system 126 generates good signals and bad signals to minimize Volume Weighted Average Price slippage, for example. Reward system 126 is configured to receive control the reinforcement learning network 110 to process input data in order to generate output signals. Input data may include trade orders, various feedback data (e.g., rewards), or feature selection data, or data reflective of completed tasks (e.g., executed trades), data reflective of trading schedules, etc. Output signals may include signals for communicating resource task requests, e.g., a request to trade in a certain security. For convenience, a good signal may be referred to as a “positive reward” or simply as a reward, and a bad signal may be referred as a “negative reward” or as a punishment.

Referring again to FIG. 1A, feature extraction unit 112 is configured to process input data to compute a variety of features. The input data can represent a trade order. Example features include pricing features, volume features, time features, Volume Weighted Average Price features, market spread features. These features may be processed to compute state data, which can be a state vector. The state data may be used as input to train an automated agent 180.

Matching engine 114 is configured to implement a training exchange defined by liquidity, counter parties, market makers and exchange rules. The matching engine 114 can be a highly performant stock market simulation environment designed to provide rich datasets and ever changing experiences to reinforcement learning networks 110 (e.g. of agents 180) in order to accelerate and improve their learning. The processor 104 may be configured to provide a liquidity filter to process the received input data for provision to the machine engine 114, for example. In some embodiments, matching engine 114 may be implemented in manners substantially as described in U.S. patent application Ser. No. 16/423,082, entitled “Trade platform with reinforcement learning network and matching engine”, filed May 27, 2019, the entire contents of which are hereby incorporated herein.

Scheduler 116 is configured to follow a historical Volume Weighted Average Price curve to control the reinforcement learning network 110 within schedule satisfaction bounds computed using order volume and order duration.

The interface unit 130 interacts with the trading platform 100 to exchange data (including control commands) and generates visual elements for display at user device. The visual elements can represent reinforcement learning networks 110 and output generated by reinforcement learning networks 110.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 120 can include memory 108, databases 122, and persistent storage 124.

The communication interface 106 can enable the platform 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The platform 100 can be operable to register and authenticate users (using a login, unique identifier, and password for example) prior to providing access to applications, a local network, network resources, other networks and network security devices. The platform 100 may serve multiple users which may operate trade entities 150a, 150b.

The data storage 120 may be configured to store information associated with or created by the components in memory 108 and may also include machine executable instructions. The data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

A reward system 126 integrates with the reinforcement learning network 110, dictating what constitutes good and bad results within the environment. In some embodiments, the reward system 126 is primarily based around a common metric in trade execution called the Volume Weighted Average Price (“VWAP”). The reward system 126 can implement a process in which VWAP is normalized and converted into the reward that is fed into models of reinforcement learning networks 110. The reinforcement learning network 110 processes one large order at a time, denoted a parent order (i.e. Buy 10000 shares of RY.TO), and places orders on the live market in small child slices (i.e. Buy 100 shares of RY.TO @ 110.00). A reward can be calculated on the parent order level (i.e. no metrics are shared across multiple parent orders that the reinforcement learning network 110 may be processing concurrently) in some embodiments.

To achieve proper learning, the reinforcement learning network 110 is configured with the ability to automatically learn based on good and bad signals. To teach the reinforcement learning network 110 how to minimize VWAP slippage, the reward system 126 provides good and bad signals to minimize VWAP slippage.

The reward system 126 can normalize the reward for provision to the reinforcement learning network 110. The processor 104 is configured to use the reward system 126 to process input data to generate Volume Weighted Average Price data. The input data can represent a parent trade order. The reward system 126 can compute reward data using the Volume Weighted Average Price and compute output data by processing the reward data using the reinforcement learning network 110. In some embodiments, reward normalization may involve transmitting trade instructions for a plurality of child trade order slices based on the generated output data.

### Other Practical Applications

As shown in FIG. 1B, automated agent 180 receives input data 185 (e.g., from one or more data sources 160 or via a data collection unit) and generates output signal 188 according to its reinforcement learning network 110. In some embodiments, the output signal 188 can be transmitted to another system, such as a control system, for executing one or more commands represented by the output signal 188.

In some embodiments, once the reinforcement learning network 110 has been trained, it generates output signal 188 reflective of its decisions to take particular actions in response to input data 185. Input data 185 can include, for example, a set of data obtained from one or more data sources 160, which may be stored in databases 170 in real time or near real time.

As a practical example, an HVAC control system which may be configured to set and control heating, ventilation, and air conditioning (HVAC) units for a building, in order to efficiently manage the power consumption of HVAC units, the control system may receive sensor data representative of temperature data in a historical period. In this example, components of the HVAC system including various elements of heating, cooling, fans, or the like may be considered resources subject of a resource task request 188. The control system may be implemented to use an automated agent 180 and a trained reinforcement learning network 110 to generate an output signal 188, which may be a resource request command signal 188 indicative of a set value or set point representing a most optimal room temperature based on the sensor data, which may be part of input data 185, representative of the temperature data in present and in a historical period (e.g., the past 72 hours or the past week).

The input data 185 may include a time series data that is gathered from sensors 160 placed at various points of the building. The measurements from the sensors 160, which form the time series data, may be discrete in nature. For example, the time series data may include a first data value 21.5 degrees representing the detected room temperature in Celsius at time t₁, a second data value 23.3 degrees representing the detected room temperature in Celsius at time t₂, a third data value 23.6 degrees representing the detected room temperature in Celsius at time t₃, and so on.

Other input data 185 may include a target range of temperature values for the particular room or space and/or a target room temperature or a target energy consumption per hour. A reward may be generated based on the target room temperature range or value, and/or the target energy consumption per hour.

In some examples, one or more automated agents 180 may be implemented, each agent 180 for controlling the room temperature for a separate room or space within the building which the HVAC control system is monitoring.

As another example, in some embodiments, a traffic control system which may be configured to set and control traffic flow at an intersection. The traffic control system may receive sensor data representative of detected traffic flows at various points of time in a historical period. The traffic control system may use an automated agent 180 and trained reinforcement learning network 110 to control a traffic light based on input data representative of the traffic flow data in real time, and/or traffic data in the historical period (e.g., the past 4 or 24 hours). In this example, components of the traffic control system including various signaling elements such as lights, speakers, buzzers, or the like may be considered resources subject of a resource task request 188.

The input data 185 may include sensor data gathered from one or more data sources 160 (e.g. sensors 160) placed at one or more points close to the traffic intersection. For example, the time series data 112 may include a first data value 3 vehicles representing the detected number of cars at time t₁, a second data value 1 vehicles representing the detected number of cars at time t₂, a third data value 5 vehicles representing the detected number of cars at time t₃, and so on.

Based on a desired traffic flow value at tₙ, the automated agent 180, based on neural network 110, may then generate an output signal 188 to shorten or lengthen a red or green light signal at the intersection, in order to ensure the intersection is least likely to be congested during one or more points in time.

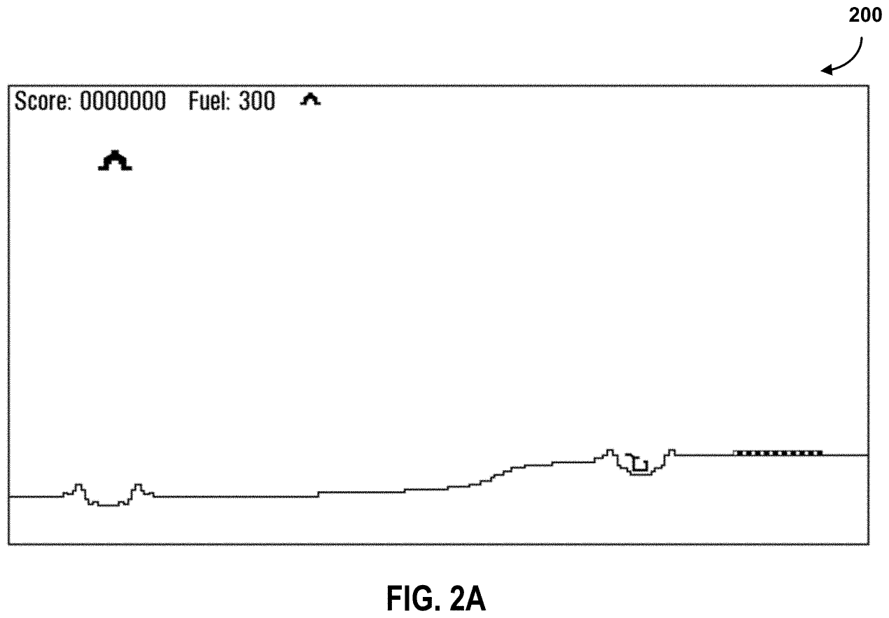

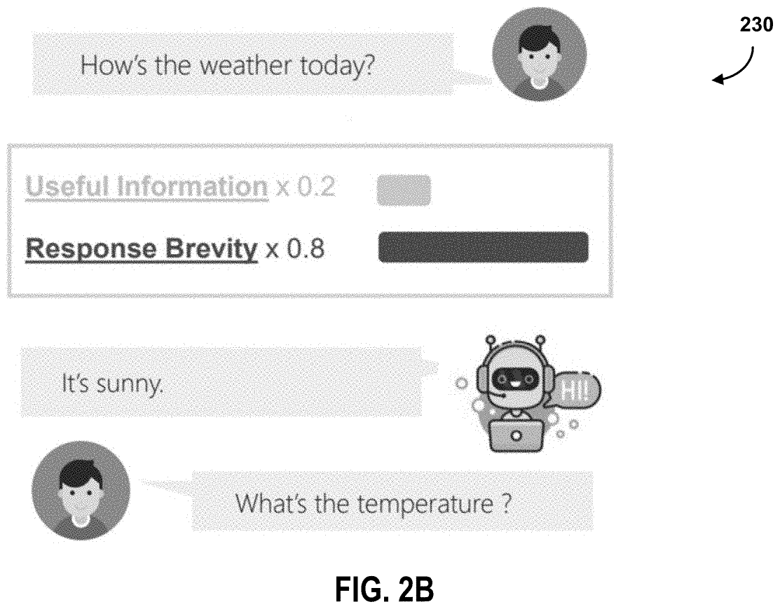

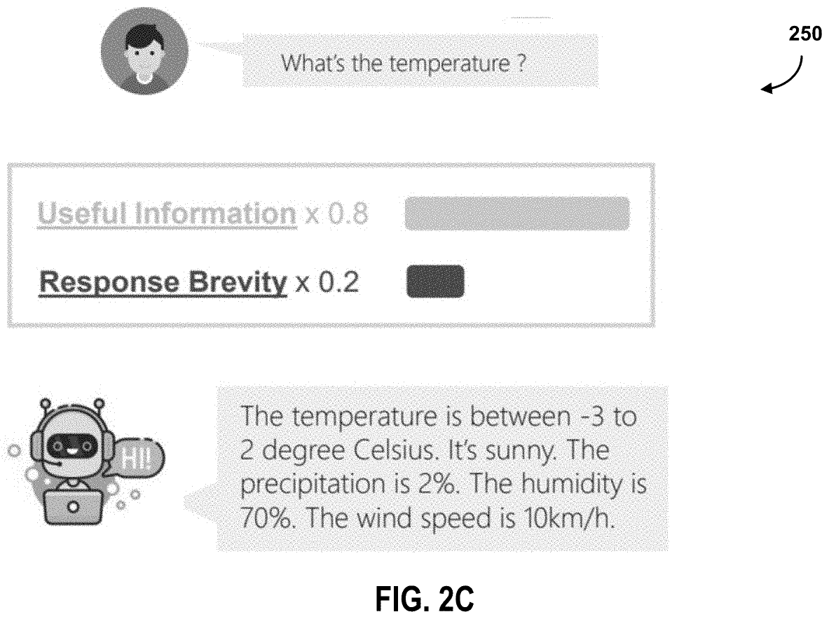

In some embodiments, as another example, an automated agent 180 in system 100 may be trained to play a video game, and more specifically, a lunar lander game 200, as shown in FIG. 2A. In this game, the goal is to control the lander's two thrusters so that it quickly, but gently, settles on a target landing pad. In this example, input data 185 provided to an automated agent 180 may include, for example, X-position on the screen, Y-position on the screen, altitude (distance between the lander and the ground below it), vertical velocity, horizontal velocity, angle of the lander, whether lander is touching the ground (Boolean variable), etc. In this example, components of the lunar lander such as its thrusters may be considered resources subject of a resource task request 188.

In some embodiments, the reward may indicate a plurality of objectives including: smoothness of landing, conservation of fuel, time used to land, and distance to a target area on the landing pad. The reward, which may be a reward vector, can be used to train the neural network 110 for landing the lunar lander by the automated agent 180.

In various embodiments, system 100 is adapted to perform certain specialized purposes. In some embodiments, system 100 is adapted to instantiate and train automated agents 180 for playing a video game such as the lunar lander game. In some embodiments, system 100 is adapted to instantiate and train automated agents 180 for implementing a chatbot that can respond to simple inquiries based on multiple client objectives. In other embodiments, system 100 is adapted to instantiate and train automated agents 180 for performing image recognition tasks. As will be appreciated, system 100 is adaptable to instantiate and train automated agents 180 for a wide range of purposes and to complete a wide range of tasks.

The reinforcement learning neural network 110, 190 may be implemented to solve a practical problem where competing interests may exist in a resource task request, based on input data 185. For example, referring now to FIG. 2B, when a chatbot is required to respond to a first query 230 such as “How's the weather today?”, the chatbot may be implemented to first determine a list of competing interests or objectives based on input data 185. A first objective may be usefulness of information, a second objective may be response brevity. The chatbot may be implemented to, based on the query 230, determine that usefulness of information has a weight of 0.2 while response brevity has a weight of 0.8. Therefore, the chatbot may proceed to generate an action (a response) that favours response brevity over usefulness of information based on a ratio of 0.8 to 0.2. Such a response may be, for example. “It's sunny.” In this example, informational responses provided by a chatbot may be considered resources subject of a resource task request 188.

For another example, referring now to FIG. 2C, when the same chatbot is required to respond to a second query 250 such as “What's the temperature?”, the chatbot may be implemented to again determine a list of competing interests or objectives input data 185. For this task or query, the first objective may still be usefulness of information, a second objective may be response brevity. The chatbot may be implemented to, based on the query 250, determine that usefulness of information has a weight of 0.8 while response brevity has a weight of 0.2. Therefore, the chatbot may proceed to generate an action (a response) that favours usefulness of information over response brevity based on a ratio of 0.8 to 0.2. Such a response may be, for example. “The temperature is between −3 to 2 degrees Celsius. It's sunny. The precipitation is 2% . . . ”.

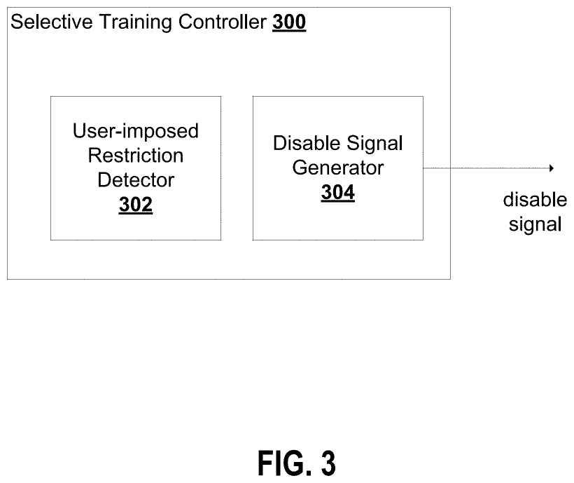

FIG. 3 is a schematic diagram of a selective training controller 300 of the platform 100, in accordance with an embodiment. The selective training controller 300 is configured to control automatically when training is performed at the platform 100, responsive to certain detected conditions. For example, the selective training controller 300 may cause the platform 100 to avoid training in the presence of certain detected conditions. In some embodiments, the selective training controller 300 may be part of the platform 100.

In some embodiments, the selective training controller 300 may be separate from the platform 100, but configured to transmit signals to and from the platform 100 to cooperate therewith.

As an automated agent 180 explores an environment, it learn and adapts its policy or policies over time based on the actions taken by the agent 180, changes in the state data reflective of a state of the environment, and the rewards provided to the agent 180 based on whether its actions achieve desired goals. Such learning and adaption occurs over a series of training cycles.

In a training cycle, the agent 180 may be provided with state data representing the current state of the environment and reward data representing a positive or negative reward corresponding to a prior action taken by the agent 180 (e.g., a prior task request generated by the agent 180). In a training cycle, responsive to the training, the agent 180 updates its policy and may have opportunity to take a new action (e.g., generate a new task request).

The selective training controller 300 causes training not to be performed at the during selected training cycles, with such selection based on certain detected conditions.

For example, it may be undesirable for training to be performed when an automated agent 180 is restricted from taking actions (e.g., generating task requests) in accordance with its policy. In such circumstances, the policy may not be improved by performing training. Such restrictions may be viewed as noise in training data, which when removed from training, can cause training to proceed more quickly. Consequently, computing resources may be conserved in such circumstances.

In some embodiments, one consequence is that the policy may improve more quickly, which may cause the automated agent 180 to perform better than a comparable automated agent 180 trained in the presence of such restrictions.

An automated agent 180 is restricted from taking actions in accordance with its policy when a user imposes a restriction on the automated agent 180. In one example, a user may substitute its own action selection in place of the action selection of the automated agent 180. In one example, a user may substitute its own policy in place of the policy of the automated agent 180. In one example, a user may prohibit the automated agent 180 from taking a certain action or prohibit the automated agent 180 from selecting a certain parameter value of an action. In one example, a user may prohibit the automated agent 180 from entering a certain portion of the environment being explored by the automated agent 180.

Such restrictions may be temporary, e.g., spanning one or more training cycles before being removed.

As depicted, the selective training controller 300 includes a user-imposed restriction detector 302 which is configured to detect one or more conditions during which a user has imposed certain restrictions on the automated agent 180. Such detection may, for example, include processing user input data defining a restriction. Such user input data may be processed in real-time or near real-time. Such user input data may be provided to the platform 100 in advance, e.g., to impose the restriction in response to a certain state of the environment or at a certain time.

In some circumstances, the user-imposed restriction detector 302 detects the timing and duration of the user-imposed restriction. In one example, the user-imposed restriction detector 302 detects that the user-imposed restriction will be in effect for a particular training cycle, e.g., the current training cycle, or an upcoming training cycle. In one example, the user-imposed restriction detector 302 detects that the user-imposed restriction will be in effect for a plurality of training cycles. In one example, the user-imposed restriction detector 302 detects a duration of time over which the user-imposed restrictions will be in effect, e.g., a number of seconds, minutes, hours, or the like. In one example, the user-imposed restriction detector 302 detects a start time and/or an end time for the user-imposed restriction. In one example, the user-imposed restriction detector 302 detects a start condition and/or an end condition for the user-imposed restriction. In one example, the user-imposed restriction detector 302 detects the end of the user-imposed restriction.

As depicted, the selective training controller 300 also includes a disable signal generator 304. In response to detection of a user-imposed restriction (e.g., including when the restriction is in effect), the disable signal generator 304 generates a disable signal to disable training of the automated agent. The disable signal generator 304 generates the disable signal corresponding to the detected start time of the restriction, which may be immediately upon detection or scheduled for later. For example, the disable signal generator 304 may generate a disable signal for a current training cycle or a future training cycle, to disable training of the automated agent 180 for that training cycle. In some embodiments, the disable signal generator 304 may maintain a disable signal for the duration of the restriction. In some embodiments, the disable signal generator 304 may generate a disable signal multiple times during the restriction (e.g., once each training cycle). In some embodiments, the disable signal generator 304 may generate a disable signal that causes training of the automated agent 180 to be disabled until a corresponding enable signal is generated the disable signal generator 304. In such embodiments, the disable signal generator 304 may generate the noted enable signal, for example, when the user-imposed restriction detector 302 detects the end of the user-imposed restriction.

The disable signal may encode data defining one or more of a start time, end time, or the particular training cycle(s) for which training is to be disabled. The disable signal may encode data identifying the particular automated agent (or agents) 180 for which training is to be disabled.

The disable signal (or enable signal if required) may be sent by the disable signal generator 304 to various components of the platform 100. In one example, a disable signal may be sent to the training engine 118, which causes the training engine 118 not to provide training data to the automated agent 180. In one example, a disable signal may be sent to the reward system 126, which causes the training engine 118 to not generate a reward for the automated agent 180. In one example, a disable signal may be sent to the particular automated agent (or agents) 180 for which training is to be disabled.

Conveniently, in the depicted embodiment, selective training controller 300 allows reinforcement learning to proceed without assumption that automated agent 180 maintains autonomous control over its action selections.

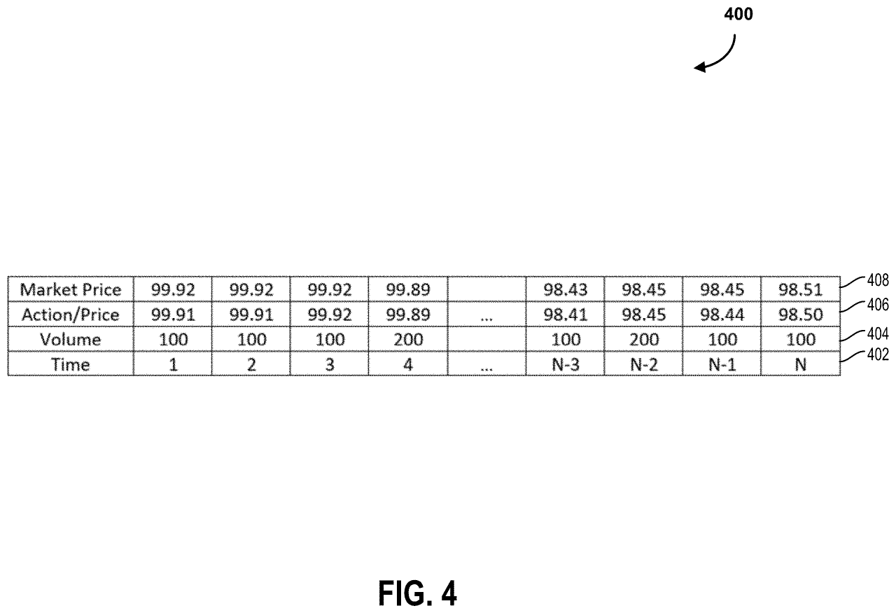

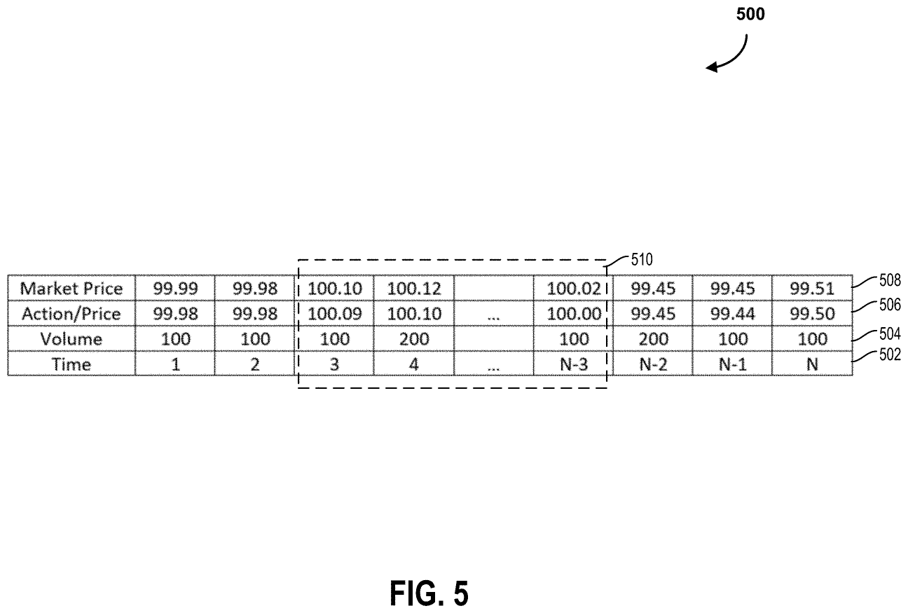

An example application of the selective training controller 300 is now described with reference to FIG. 4 and FIG. 5.

In this example, the automated agent 180 is trained to trade securities. In this example, the automated agent 180 is responsible for executing on a buy order for a given stock. Of course, in other example, the automated agent 180 may be responsible for executing on a sell order, or perform another type of trade, or perform an action in relation to another type of security. The goal of the automated agent 180 is to minimize slippage (and maximize reward provided for minimizing slippage), but there may be other goals or sub-goals. The slippage may, for example, be a VWAP slippage as described herein.

As depicted in FIG. 4, a particular buy order may be executed over N time steps. The automated agent 180 may decide on the price that it wishes to execute a fraction of the total order (a slice) during each time step.

Each time step corresponds to a training cycle as the automated agent 180 may receive updated state data and reward data at each time step and be trained over the course of the order (i.e., at each time step).

FIG. 4 shows a summary of actions dictated by the policy of the automated agent 180, namely, for each time step 402, the volume 404 of the stock (slice) to be bought at that time step, the action price 406 for the slice of the order at that time step, and the market price 408 during that time step. As noted, the automated agent 180 may be trained based on its action and performance (e.g., slippage) at each time step.

FIG. 5 depicts actions dictated by the policy of the automated agent 180 for another buy order to be executed over N time steps, namely, for each time step 502, the volume 504 of the stock (slice) to be bought at that time step, the action price 506 for the slice of the order at that time step, and the market price 508 during that time step

However, in this example, a user (e.g., a client) has set a restriction on the highest price that the automated agent 180 can act on, which may be referred to as a “limit” price. For example, the limit price may be set by the user at $100, which means that the automated agent 180 cannot act on the market with a price higher than $100. Consequently, the actions proposed by the automated agent 180 during the time frame 510 when the market price is higher than $100 are not taken. In this circumstance, the state of the environment is not impacted by the automated agent 180, and no useful comparison of the performance of the automated agent 180 relative to the market is available. In accordance with the depicted embodiment, training during this time frame is to be avoided.

This restriction in the form of a “limit” price is detected by the user-imposed restriction detector 302, and such detection causes the disable signal generator 304 to generate one or more disable signals to cause training of the automated agent 180 to be disabled during each time step in time frame 510 (i.e., time steps 3 through N−3).

Various forms of user-imposed restrictions can be detected and acted upon by the selective training controller 300 to cause training to be disabled. For example, such user-imposed restrictions may include a user input dictating a slice size, a stop price, or other trade parameter. In one example, a user-imposed restriction may include a user input for manually adjusting an aggression level of the automated agent 180. In another example, a user-imposed restriction may include a maximum Percentage of Volume limit (e.g., a percentage of the current market volumes) imposed on the automated agent 180. In another example, a user-imposed restriction may relate to scheduling constraints.

Embodiments have been described above in which training is disabled upon detection of user-imposed restrictions. In some embodiments, training can also be disabled upon detection of another type of learning condition that is expected to impede training of automated agent 180. In such embodiments, user-implemented restriction detector 302 may be replaced by another detector configured to detect such other type of learning condition.

For example, such other types of learning conditions may include atypical conditions of the environment that automated agent 180 is exploring. For example, where the environment includes a trading venue, such atypical conditions may include circumstances of market conditions that are atypical. Because the conditions are atypical, and therefore indicative of an outlier experience, it is likely not useful to learn from such experiences.

In one example, an atypical market condition is detected when processing of state data indicates that a far touch action selected by automated agent 180 (e.g., making a request for a resource at the asking price) has been rejected. Typically, when making a request to obtain a resource at the asking price, it is expected that the request is fulfilled. Rejection of this type of request indicates that an action taken by automated agent 180 is not producing the corresponding expected outcome. It may not be desirable to allow automated agent 180 to learn from such experiences.

In another example, an atypical market condition is detected when processing of state data indicates that liquidity of a particular resource is atypically constrained.

In another example, an atypical market condition may include circumstances outside the control of the automated agent 180 which cause the automated agent 180 to get too far ahead or too far behind a request schedule (e.g., as defined by scheduler 116). For example, the request schedule for a given resource may be defined by an expected curve indicating typical volumes as a function of the time of day. In some cases, the expected curve may be defined based on absolute volumes (e.g., 1000 units of a resource by 9:30 am). In some cases, the expected curve may defined based on a cumulative percentage (e.g., 10% of the day's resource requests, by volume by 9:30 am).

An atypical market condition is detected when resource requests of automated agent 180 have deviated from the expected curve by a predefined amount (e.g., +/−5%, +/−10%, or the like). The expected curve may be defined based on averaged data for a preceding time period (e.g., prior 20 days, prior 40 days, or the like).

In an embodiment in which automated agent 180 is a trading agent configured to trade securities, the expected curve may define the number of shares that is expected to be traded at a particular time of day (e.g., 9:30 am, 12:00 μm, or the like). For example, the curve may indicate that by 9:30 am, 2000 shares of a stock should have been traded. If actual performance of the trading agent on a given day is such that the number of shares traded by 9:30 am is 10% lower (or higher) than 2000 shares, then an atypical environment condition is flagged.

Another example application of the selective training controller 300 may be described with reference to an automated agent 180 configured to control a vehicle (e.g., a self-driving car). In this example, the selective training controller 300 causes training of the automated agent 180 to be disabled upon detecting that a human driver has taken control or overridden an aspect of the automated control of the vehicle, e.g., by taking control of the steering wheel, by operating the gas or brake pedals, or the like._{[NRFC IP1]}

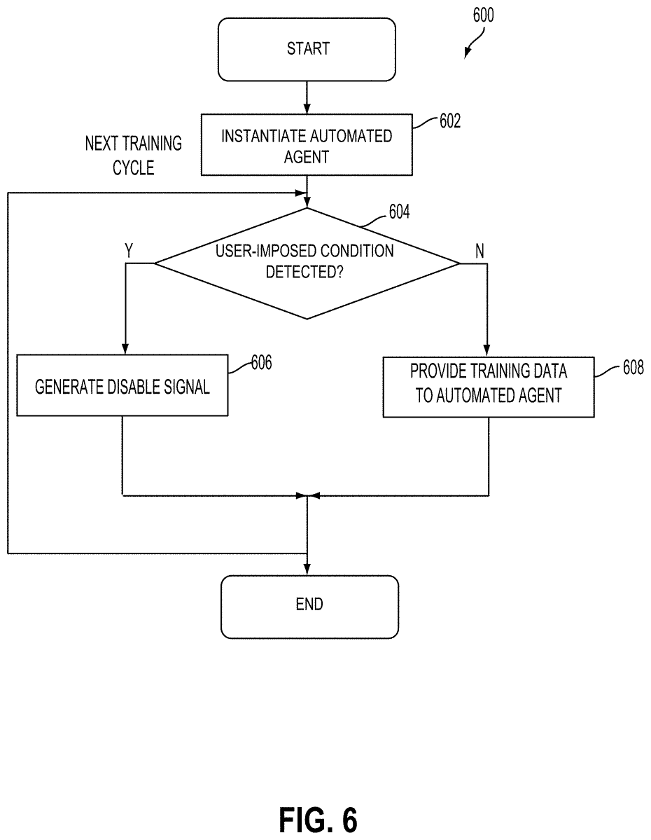

The operation of the platform 100 (including the selective training controller 300) is further described with reference to the flowchart depicted in FIG. 6. The platform 100 performs the example operations depicted at blocks 600 and onward, in accordance with an embodiment.

At block 602, the platform 100 instantiate an automated agent 180 that includes a reinforcement learning neural network 110. The automated agent 180 provides a policy for generating resource task requests within an environment under exploration by the automated agent.

Training and operation of the automated agent 180 proceeds over a plurality of training cycles.

At block 604, during a given training cycle, the platform 100 (e.g., user-imposed restriction detector 302 or other suitable detector) detects a learning condition that is expected to impede training of the automated agent. The learning condition may include, for example, a user-imposed restriction that restricts the automated agent 180 from generating a resource task request in accordance with its policy. The learning condition may include, for example, an atypical condition of the environment being explored.

This detection may include processing the state data to determine that the learning condition is likely to impede training of the automated agent 180 given the current state of the environment. For example, processing the state data may determine that the learning condition restricts the automated agent given the state of the environment. In one example, processing the state data includes determining that the market price. This allows the user-imposed restriction detector 302 to determine that a limit price imposed by a user restricts the automated agent 180 given the market price.

In response to detecting such a learning condition, operation of the platform 100 proceeds to block 606. At block 606, the platform 100 (e.g., the disable signal generator 304) generates a disable signal to disable training of the automated agent 180 for the given training cycle. This disable signal may be sent to various components of the platform 100 to cause, for example, processing of a reward to be disabled for the given training cycle, or to prevent state data from being provided to the automated agent 180 to be disabled for the given training cycle. This in turn, prevents the reward or state data from being provided to the reinforcement learning network 110 of the automated agent 180 for the given training cycle. As noted, the disable signal can also cause training to be disabled for several training cycles.

When the learning condition is not detected for the given training cycle, operation instead proceeds to block 608. At block 608, training may be performed as in the normal course. For example, training data may be provided to the automated agent 180 as described herein. Such training data may include, for example, state data (e.g., reflective of a current state of the environment). Such training data may also include, for example, a reward as generated by reward system 126.

From block 606 or block 608, operation proceeds to the next training cycle.

It should be understood that steps of one or more of the blocks depicted in FIG. 6 may be performed in a different sequence or in an interleaved or iterative manner. Further, variations of the steps, omission or substitution of various steps, or additional steps may be considered.

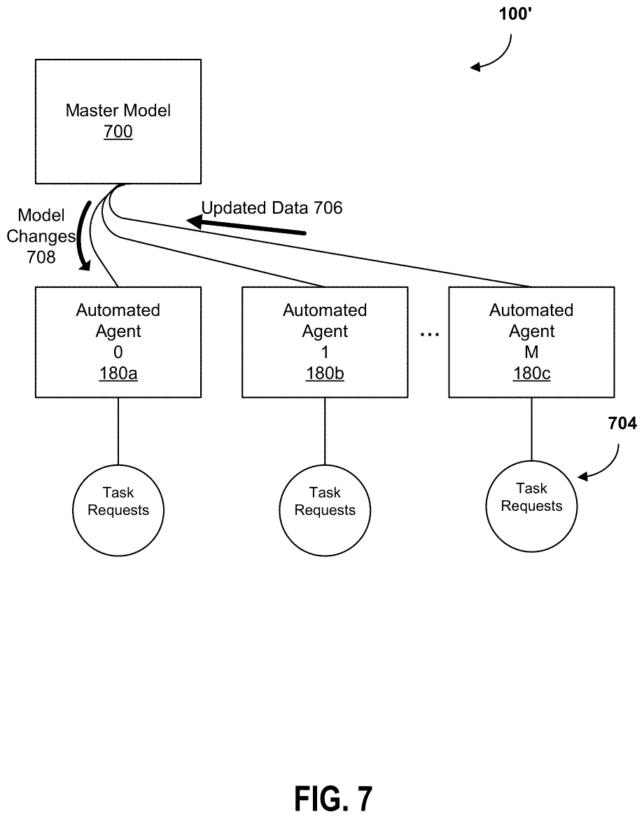

FIG. 7 depicts an embodiment of platform 100′ having a plurality of automated agents 180a, 180b, 180c. In this embodiment, data storage 120 stores a master model 700 that includes data defining a reinforcement learning neural network for instantiating one or more automated agents 180a, 180b, 180c.

During operation, platform 100′ instantiates a plurality of automated agents 180a, 180b, 180c according to master model 700 and each automated agent 180a, 180b, 180c performs operations described herein. For example, each automated agent 180a, 180b, 180c generates tasks requests 704 according to outputs of its reinforcement learning neural network 110.

As the automated agents 180a, 180b, 180c learn during operation, platform 100′ obtains updated data 706 from one or more of the automated agents 180a, 180b, 180c reflective of learnings at the automated agents 180a, 180b, 180c. Updated data 706 includes data descriptive of an “experience” of an automated agent in generating a task request. Updated data 706 may include one or more of: (i) input data to the given automated agent 180a, 180b, 180c and applied normalizations (ii) a list of possible resource task requests evaluated by the given automated agent with associated probabilities of making each requests, and (iii) one or more rewards for generating a task request.

Platform 100′ processes updated data 706 to update master model 700 according to the experience of the automated agent 180a, 180b, 180c providing the updated data 706. Consequently, automated agents 180a, 180b, 180c instantiated thereafter will have benefit of the learnings reflected in updated data 706. Platform 100′ may also sends model changes 708 to the other automated agents 180a, 180b, 180c so that these pre-existing automated agents 180a, 180b, 180c will also have benefit of the learnings reflected in updated data 706. In some embodiments, platform 100′ sends model changes 708 to automated agents 180a, 180b, 180c in quasi-real time, e.g., within a few seconds, or within one second. In one specific embodiment, platform 100′ sends model changes 708 to automated agents 180a, 180b, 180c using a stream-processing platform such as Apache Kafka, provided by the Apache Software Foundation. In some embodiments, platform 100′ processes updated data 706 to optimize expected aggregate reward across based on the experiences of a plurality of automated agents 180a, 180b, 180c.

In some embodiments, platform 100′ obtains updated data 706 after each time step. In other embodiments, platform 100′ obtains updated data 706 after a predefined number of time steps, e.g., 2, 5, 10, etc. In some embodiments, platform 100′ updates master model 700 upon each receipt updated data 706. In other embodiments, platform 100′ updates master model 700 upon reaching a predefined number of receipts of updated data 706, which may all be from one automated agent or from a plurality of automated agents 180a, 180b, 180c.

In one example, platform 100′ instantiates a first automated agent 180a, 180b, 180c and a second automated agent 180a, 180b, 180c, each from master model 700. Platform 100′ obtains updated data 706 from the first automated agents 180a, 180b, 180c. Platform 100′ modifies master model 700 in response to the updated data 706 and then applies a corresponding modification to the second automated agent 180a, 180b, 180c. Of course, the roles of the automated agents 180a, 180b, 180c could be reversed in another example such that platform 100′ obtains updated data 706 from the second automated agent 180a, 180b, 180c and applies a corresponding modification to the first automated agent 180a, 180b, 180c.

In some embodiments of platform 100′, an automated agent may be assigned all tasks for a parent order. In other embodiments, two or more automated agent 700 may cooperatively perform tasks for a parent order; for example, child slices may be distributed across the two or more automated agents 180a, 180b, 180c.

In the depicted embodiment, platform 100′ may include a plurality of I/O units 102, processors 104, communication interfaces 106, and memories 108 distributed across a plurality of computing devices. In some embodiments, each automated agent may be instantiated and/or operated using a subset of the computing devices. In some embodiments, each automated agent may be instantiated and/or operated using a subset of available processors or other compute resources. Conveniently, this allows tasks to be distributed across available compute resources for parallel execution. Other technical advantages include sharing of certain resources, e.g., data storage of the master model, and efficiencies achieved through load balancing. In some embodiments, number of automated agents 180a, 180b, 180c may be adjusted dynamically by platform 100′. Such adjustment may depend, for example, on the number of parent orders to be processed. For example, platform 100′ may instantiate a plurality of automated agents 180a, 180b, 180c in response to receive a large parent order, or a large number of parent orders. In some embodiments, the plurality of automated agents 180a, 180b, 180c may be distributed geographically, e.g., with certain of the automated agent 180a, 180b, 180c placed for geographic proximity to certain trading venues.

In some embodiments, the operation of platform 100′ adheres to a master-worker pattern for parallel processing. In such embodiments, each automated agent 180a, 180b, 180c may function as a “worker” while platform 100′ maintains the “master” by way of master model 700.

Platform 100′ is otherwise substantially similar to platform 100 described herein and each automated agent 180a, 180b, 180c is otherwise substantially similar to automated agent 180 described herein.

Pricing Features: In some embodiments, input normalization may involve the training engine 118 computing pricing features. In some embodiments, pricing features for input normalization may involve price comparison features, passive price features, gap features, and aggressive price features.

Price Comparing Features: In some embodiments, price comparison features can capture the difference between the last (most current) Bid/Ask price and the Bid/Ask price recorded at different time intervals, such as 30 minutes and 60 minutes ago: qt_Bid30, qt_Ask30, qt_Bid60, qt_Ask60. A bid price comparison feature can be normalized by the difference of a quote for a last bid/ask and a quote for a bid/ask at a previous time interval which can be divided by the market average spread. The training engine 118 can “clip” the computed values between a defined ranged or clipping bound, such as between −1 and 1, for example. There can be 30 minute differences computed using clipping bound of −5, 5 and division by 10, for example.

An Ask price comparison feature (or difference) can be computed using an Ask price instead of Bid price. For example, there can be 60-minute differences computed using clipping bound of −10, 10 and division by 10.

Passive Price: The passive price feature can be normalized by dividing a passive price by the market average spread with a clipping bound. The clipping bound can be 0, 1, for example.

Gap: The gap feature can be normalized by dividing a gap price by the market average spread with a clipping bound. The clipping bound can be 0, 1, for example.

Aggressive Price: The aggressive price feature can be normalized by dividing an aggressive price by the market average spread with a clipping bound. The clipping bound can be 0, 1, for example.

Volume and Time Features: In some embodiments, input normalization may involve the training engine 118 computing volume features and time features. In some embodiments, volume features for input normalization involves a total volume of an order, a ratio of volume remaining for order execution, and schedule satisfaction. In some embodiments, the time features for input normalization involves current time of market, a ratio of time remaining for order execution, and a ratio of order duration and trading period length.

Ratio of Order Duration and Trading Period Length: The training engine 118 can compute time features relating to order duration and trading length. The ratio of total order duration and trading period length can be calculated by dividing a total order duration by an approximate trading day or other time period in seconds, minutes, hours, and so on. There may be a clipping bound.

Current Time of the Market: The training engine 118 can compute time features relating to current time of the market. The current time of the market can be normalized by the different between the current market time and the opening time of the day (which can be a default time), which can be divided by an approximate trading day or other time period in seconds, minutes, hours, and so on.

Total Volume of the Order: The training engine 118 can compute volume features relating to the total order volume. The training engine 118 can train the reinforcement learning network 110 using the normalized order count. The total volume of the order can be normalized by dividing the total volume by a scaling factor (which can be a default value).

Ratio of time remaining for order execution: The training engine 118 can compute time features relating to the time remaining for order execution. The ratio of time remaining for order execution can be calculated by dividing the remaining order duration by the total order duration. There may be a clipping bound.

Ratio of volume remaining for order execution: The training engine 118 can compute volume features relating to the remaining order volume. The ratio of volume remaining for order execution can be calculated by dividing the remaining volume by the total volume. There may be a clipping bound.

Schedule Satisfaction: The training engine 118 can compute volume and time features relating to schedule satisfaction features. This can give the model a sense of how much time it has left compared to how much volume it has left. This is an estimate of how much time is left for order execution. A schedule satisfaction feature can be computed the a different of the remaining volume divided by the total volume and the remaining order duration divided by the total order duration. There may be a clipping bound.

VWAPs Features: In some embodiments, input normalization may involve the training engine 118 computing Volume Weighted Average Price features. In some embodiments, Volume Weighted Average Price features for input normalization may involve computing current Volume Weighted Average Price features and quoted Volume Weighted Average Price features.

Current VWAP: Current VWAP can be normalized by the current VWAP adjusted using a clipping bound, such as between −4 and 4 or 0 and 1, for example.

Quote VWAP: Quote VWAP can be normalized by the quoted VWAP adjusted using a clipping bound, such as between −3 and 3 or −1 and 1, for example.

Market Spread Features In some embodiments, input normalization may involve the training engine 118 computing market spread features. In some embodiments, market spread features for input normalization may involve spread averages computed over different time frames.

Several spread averages can be computed over different time frames according to the following equations.

Spread average: Spread average can be the difference between the bid and the ask on the exchange (e.g., on average how large is that gap). This can be the general time range for the duration of the order. The spread average can be normalized by dividing the spread average by the last trade price adjusted using a clipping bound, such as between 0 and 5 or 0 and 1, for example.

Spread a: Spread a can be the bid and ask value at a specific time step. The spread can be normalized by dividing the spread by the last trade price adjusted using a clipping bound, such as between 0 and 2 or 0 and 1, for example.

Bounds and Bounds Satisfaction In some embodiments, input normalization may involve computing upper bounds, lower bounds, and a bounds satisfaction ratio. The training engine 118 can train the reinforcement learning network 110 using the upper bounds, the lower bounds, and the bounds satisfaction ratio.

Upper Bound: Upper bound can be normalized by multiplying an upper bound value by a scaling factor (such as 10, for example).

Lower Bound: Lower bound can be normalized by multiplying a lower bound value by a scaling factor (such as 10, for example).

Bounds Satisfaction Ratio: Bounds satisfaction ratio can be calculated by a difference between the remaining volume divided by a total volume and remaining order duration divided by a total order duration, and the lower bound can be subtracted from this difference. The result can be divided by the difference between the upper bound and the lower bound. As another example, bounds satisfaction ratio can be calculated by the difference between the schedule satisfaction and the lower bound divided by the difference between the upper bound and the lower bound.

Queue Time: In some embodiments, platform 100 measures the time elapsed between when a resource task (e.g., a trade order) is requested and when the task is completed (e.g., order filled), and such time elapsed may be referred to as a queue time. In some embodiments, platform 100 computes a reward for reinforcement learning neural network 110 that is positively correlated to the time elapsed, so that a greater reward is provided for a greater queue time. Conveniently, in such embodiments, automated agents may be trained to request tasks earlier which may result in higher priority of task completion.

Orders in the Order Book: In some embodiments, input normalization may involve the training engine 118 computing a normalized order count or volume of the order. The count of orders in the order book can be normalized by dividing the number of orders in the order book by the maximum number of orders in the order book (which may be a default value). There may be a clipping bound.

In some embodiments, the platform 100 can configured interface application 130 with different hot keys for triggering control commands which can trigger different operations by platform 100.

One Hot Key for Buy and Sell: In some embodiments, the platform 100 can configured interface application 130 with different hot keys for triggering control commands. An array representing one hot key encoding for Buy and Sell signals can be provided as follows:

Buy: [1, 0]

Sell: [0, 1]

One Hot Key for action: An array representing one hot hey encoding for task actions taken can be provided as follows:

Pass: [1, 0, 0, 0, 0, 0]

Aggressive: [0, 1, 0, 0, 0, 0,]

Top: [0, 0, 1, 0, 0, 0]

Append: [0, 0, 0, 1, 0, 0]

Prepend: [0, 0, 0, 0, 1, 0]

Pop: [0, 0, 0, 0, 0, 1]

In some embodiments, other task actions that can be requested by an automated agent include:

Far touch—go to ask

Near touch—place at bid

Layer in—if there is an order at near touch, order about near touch

Layer out—if there is an order at far touch, order close far touch

Skip—do nothing

Cancel—cancel most aggressive order

In some embodiments, the fill rate for each type of action is measured and data reflective of fill rate is included in task data received at platform 100.

In some embodiments, input normalization may involve the training engine 118 computing a normalized market quote and a normalized market trade. The training engine 118 can train the reinforcement learning network 110 using the normalized market quote and the normalized market trade.

Market Quote: Market quote can be normalized by the market quote adjusted using a clipping bound, such as between −2 and 2 or 0 and 1, for example.

Market Trade: Market trade can be normalized by the market trade adjusted using a clipping bound, such as between −4 and 4 or 0 and 1, for example.

Spam Control: The input data for automated agents 180 may include parameters for a cancel rate and/or an active rate.

Scheduler: In some embodiment, the platform 100 can include a scheduler 116. The scheduler 116 can be configured to follow a historical Volume Weighted Average Price curve to control the reinforcement learning network 110 within schedule satisfaction bounds computed using order volume and order duration. The scheduler 116 can compute schedule satisfaction data to provide the model or reinforcement learning network 110 a sense of how much time it has in comparison to how much volume remains. The schedule satisfaction data is an estimate of how much time is left for the reinforcement learning network 110 to complete the requested order or trade. For example, the scheduler 116 can compute the schedule satisfaction bounds by looking at a different between the remaining volume over the total volume and the remaining order duration over the total order duration.

In some embodiments, automated agents may train on data reflective of trading volume throughout a day, and the generation of resource requests by such automated agents need not be tied to historical volumes. For example, conventionally, some agent upon reaching historical bounds (e.g., indicative of the agent falling behind schedule) may increase aggression to stay within the bounds, or conversely may also increase passivity to stay within bounds, which may result in less optimal trades.

The scheduler 116 can be configured to follow a historical VWAP curve. The difference is that he bounds of the scheduler 116 are fairly high, and the reinforcement learning network 110 takes complete control within the bounds.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

1. A computer-implemented system for training an automated agent, the system comprising:
a communication interface;
at least one processor;
memory in communication with the at least one processor; and
software code stored in the memory, which when executed at the at least one processor causes the system to:
instantiate an automated agent that includes a reinforcement learning neural network that is trained over a plurality training cycles and provides a policy for generating resource task requests within an environment under exploration by the automated agent;
detect a learning condition that is expected to impede training of the automated agent during a given training cycle of the plurality of training cycles; and
in response to the detecting, generate a disable signal to disable training of the automated agent for at least the given training cycle.

2. The computer-implemented system of claim 1, wherein the software code, when executed at the at least one processor further causes the system to:
receive state data reflective of a current state of the environment.

3. The computer-implemented system of claim 2, wherein the detecting the learning condition includes processing the state data to determine that the learning condition restricts the automated agent given the current state of the environment.

4. The computer-implemented system of claim 1, wherein the learning condition includes a user-imposed restriction that restricts the automated agent from generating a resource task request in accordance with its policy.

5. The computer-implemented system of claim 3, wherein the learning condition includes a limit price, and the current state includes a market price.

6. The computer-implemented system of claim 1, wherein the learning condition includes an atypical condition of the environment.

7. The computer-implemented system of claim 1, wherein the environment includes at least one trading venue.

8. The computer-implemented system of claim 1, wherein the software code, when executed at the at least one processor further causes the system to:
upon receiving the disable signal, disable processing of a reward for the given training cycle.

9. The computer-implemented system of claim 2, wherein the software code, when executed at the at least one processor further causes the system to:
upon receiving the disable signal, disable providing the state data to the reinforcement learning neural network for the given training cycle.

10. A computer-implemented method for training an automated agent, the method comprising:
instantiating an automated agent that includes a reinforcement learning neural network that is trained over a plurality training cycles and provides a policy for generating resource task requests within an environment under exploration by the automated agent;
detecting a learning condition that is expected to impede training of the automated agent during a given training cycle of the plurality of training cycles; and
in response to the detecting, generating a disable signal to disable training of the automated agent for at least the given training cycle.

11. The computer-implemented method of claim 10, further comprising:
generating a reward for the reinforcement learning neural network.

12. The computer-implemented method of claim 16, further comprising:
when the learning condition is not detected, providing the reward to the reinforcement learning neural network.

13. The computer-implemented method of claim 10, further comprising:
receiving state data reflective of a current state of the environment.

14. The computer-implemented method of claim 13, further comprising:
when the learning condition is not detected, providing the state data to the reinforcement learning neural network.

15. The computer-implemented method of claim 13, wherein the detecting the learning condition includes processing the state data to determine that the learning condition is expected to impede training of the automated agent given the current state of the environment.

16. The computer-implemented method of claim 10, wherein the learning condition includes a user-imposed restriction that restricts the automated agent from generating a resource task request in accordance with its policy.

17. The computer-implemented method of claim 15, wherein the learning condition includes a limit price, and the current state includes a market price.

18. The computer-implemented method of claim 10, wherein the learning condition includes an atypical condition of the environment.

19. The computer-implemented method of claim 10, further comprising:
upon receiving the disable signal, disabling processing of a reward for the given training cycle.

20. The computer-implemented method of claim 11, further comprising:
upon receiving the disable signal, disable providing the state data to the reinforcement learning neural network for the given training cycle.

21. A non-transitory computer-readable storage medium storing instructions which when executed adapt at least one computing device to:
instantiate an automated agent that includes a reinforcement learning neural network that is trained over a plurality training cycles and provides a policy for generating resource task requests;
detect a learning condition that is expected to impede training of the automated agent during a given training cycle of the plurality of training cycles; and
in response to the detecting, generate a disable signal to disable training of the automated agent for at least the given training cycle.
